(19) United States
(12) Patent Application Publication
(10) Pub. No.: US 2025/0364871 A1
(43) Pub. Date: Nov. 27, 2025

(54) INTEGRAL EXPANDER GENERATOR FOR HYDROGEN APPLICATIONS WITH MAGNETIC BEARINGS

(71) Applicant: NUOVO PIGNONE TECNOLOGIE -S.R.L., Florence (IT)

(72) Inventors: Massimiliano ORTIZ NERI, Florence, Firenze (IT); Matteo DOZZINI, Florence, Firenze (IT); Francesco CANGIOLI, Florence, Firenze (IT)

(21) Appl. No.: 18/867,219

(22) PCT Filed: May 18, 2023
(86) PCT No.: PCT/EP2023/025232

§ 371 Date: Nov. 19, 2024

(30) Foreign Application Priority Data
May 24, 2022 (IT) 102022000010697

(51) Int. Cl. H02K 7/18; H02K 7/09; H02K 9/12

(52) U.S. Cl. CPC H02K 7/1823; H02K 7/09; H02K 9/12

(57) ABSTRACT

An expander generator machine for hydrogen application has a machine inlet and a machine outlet and comprises an impeller which expands hydrogen and which is directly connected to an electric generator and at least one magnetic bearing cooled by a flow of hydrogen taken from the machine inlet. The expander generator machine is located inside a casing and preferably the hydrogen flows through suitable paths inside the casing to cool the at least one magnetic bearing. Advantageously, the electric generator is also cooled by a flow of hydrogen taken from the machine inlet.

### TECHNICAL FIELD

The subject-matter disclosed herein relates to a hydrogen expander generator with magnetic bearings. More particularly, the subject-matter disclosed herein relates to an integral expander generator which allows to use hydrogen as cooling fluid for magnetic bearings and possibly the electric generator.

### BACKGROUND ART

A hydrogen expander generator is a rotating machine which expands a fluid through an impeller in order to release expansion work which drives the impeller to rotate. Typically, the impeller is mechanically coupled to a transmission mechanism which transmits the rotation to a shaft of an electric generator, thus generating electrical energy. If both the impeller and the electric generator are housed in a common casing, it is referred to as an integrated machine.

Hydrogen applications are becoming more and more relevant in the energy transition; however, several disadvantages and potential risks are known from using hydrogen in rotating machines, in particular in expander generators. For example, documents CN113374538A and CN113374581A aim to overcome the problem of leakage of hydrogen in expander generators for hydrogen applications, which may cause an explosion hazard due to the small critical ignition energy of hydrogen. According to these documents, a rotary seal (such as a the one generated by dry gas seals) is established between the rotating shaft and the casing by using an inert and isolating gas, such as nitrogen. Moreover, it is known from document CN113513580A to use a lubricating system for lubricating a reduction box located between the hydrogen expander and the power generator which reduces the rotating speed of the shaft of the generator, typically to accomplish the rotating speed requirements of mechanical bearings and other rotating mechanical parts.

However, it is desirable to have a safe high-speed rotation machine which does not require introduction of operating gas and/or liquids (such as sealing gas or lubricating).

### SUMMARY

According to an aspect, the subject-matter disclosed herein relates to an expander generator machine receiving hydrogen from a machine inlet and discharging expanded hydrogen to a machine outlet comprising an impeller mechanically connected to an electric generator and further comprising at least one magnetic bearing cooled by a flow of hydrogen taken from the machine inlet. The expander generator machine is located inside a casing. According to some embodiments, the flow of hydrogen taken from the machine inlet flows through suitable paths inside the casing to cool at least the magnetic bearing(s). Advantageously, also the electric generator is cooled by a flow of hydrogen taken from the machine inlet. According to some embodiments, hydrogen is used to cool only the electric generator and not the magnetic bearing(s).

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic view of a first embodiment of an innovative expander generator machine with radial magnetic bearing cooled by hydrogen coming from the machine inlet,

FIG. 2 shows a schematic view of a second embodiment of an innovative expander generator machine with radial magnetic bearing cooled by hydrogen coming from the machine inlet and which discharges heated hydrogen at the machine outlet,

FIG. 3 shows a schematic view of a third embodiment of an innovative expander generator machine with radial magnetic bearing and thrust magnetic bearing cooled by hydrogen coming from the machine inlet and which discharge heated hydrogen at the machine outlet and electric generator cooled by a cooling fluid,

FIG. 4 shows a schematic view of a fourth embodiment of an innovative expander generator machine with radial magnetic bearings, thrust magnetic bearing and electric generator some cooled by a first flow of hydrogen and some cooled by a second flow of hydrogen (both coming from the machine inlet) and which discharge heated hydrogen at the machine outlet,

FIG. 5 shows a schematic view of a fifth embodiment of an innovative expander generator machine with radial magnetic bearings, thrust magnetic bearing and electric generator cooled by a same flow of hydrogen coming from the machine inlet and which discharge heated hydrogen at the machine outlet, and

FIG. 6 shows a schematic view of a sixth embodiment of an innovative expander generator machine with radial magnetic bearings, thrust magnetic bearing and electric generator, some cooled by a first flow of hydrogen coming from the machine inlet and some by a second flow of hydrogen coming from the machine outlet and which discharge heated hydrogen at the machine outlet.

### DETAILED DESCRIPTION OF EMBODIMENTS

According to an aspect, the subject-matter disclosed herein relates to a rotating machine for generating electrical energy which expands hydrogen through an impeller that is rotating due to the energy released during hydrogen expansion. The impeller receives hydrogen from a machine inlet; the hydrogen is expanded by the impeller while flowing through impeller vanes and finally the expanded hydrogen is discharged to a machine outlet. The impeller is directly connected to a shaft of an electric generator which has a rotary part integral with the shaft and a stator part integral with the casing, generating electrical energy thanks to the rotation of the shaft which generates a rotating magnetic field. A first portion of hydrogen fed to the machine inlet is deviated and used to cool at least one magnetic bearing (which may be a radial bearing or a thrust bearing) acting on the shaft and then advantageously send to the machine outlet, in order to be mixed with the hydrogen expanded and discharged by the impeller. Advantageously, a second portion of the hydrogen fed to the machine inlet is deviated and used to cool the electric generator. It is to be noted that, according to some embodiments, the first portion of hydrogen used to cool at least one magnetic bearing and the second portion of the hydrogen used to cool the electric generator may be a same flow of hydrogen.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

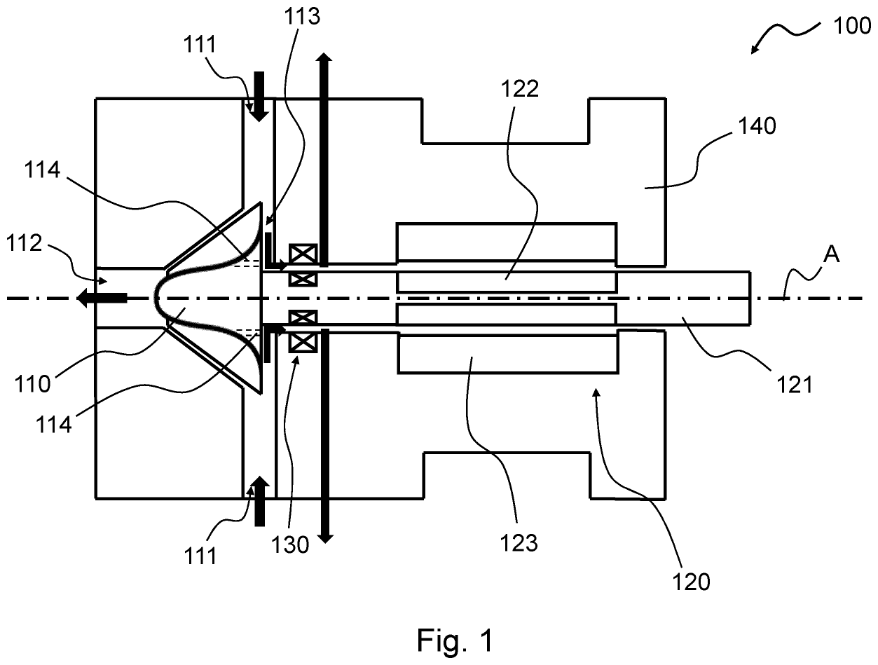

In FIG. 1 is schematically shown a first embodiment of an innovative expander generator machine (“expander generator” in the following) generally indicated with reference numeral 100. Moreover, for the sake of clarity, in FIG. 1 (and in general in all the Figures) a very schematic circulation of hydrogen in the expander generator is highlighted (see the numerous black arrows in Figures). It is to be noted that other fluids may circulate within the expander generator (as i1 will be explained below). Typically, with non-limiting reference to FIG. 1, the expander generator 100 has a machine inlet 111 and a machine outlet 112 and comprises an impeller 110, configured to expand hydrogen, and an electric generator 120, configured to generate electrical energy, both the impeller 110 and the electric generator 120 being housed into a casing 140.

The impeller 110, in particular a radial inflow turbine, is configured to receive compressed hydrogen fed to the inlet 111 of the machine and expand it, releasing expansion work; for example, in FIG. 1, two machine inlets 111 are shown which are located opposite to each other with respect to a central axis A of the expander generator 100. In particular, the impeller 110 has a plurality of impeller vanes which define a plurality of passages through which the hydrogen flows and is expanded, being then discharged as expanded hydrogen at the machine outlet 112. Hence, the hydrogen fed to the impeller 110 decreases pressure and temperature from the inlets 111 to the outlet 112 of the machine. Typically, the compressed hydrogen fed to machine inlets 111 is already at very low temperature, for example from −230° C. to −150° C.

As already mentioned before, the expansion of hydrogen through the impeller 110 release expansion work which may drive the impeller 110. With non-limiting reference to FIG. 1, the impeller 110 is mechanically connected, in particular directly (i.e. without further elements between them), to the electric generator 120, which is preferably a permanent magnet electric generator.

More specifically, the electric generator 120 comprises a rotary hub 121 and a rotary magnetic assembly 122 mechanically coupled to the rotary hub 121, wherein the impeller 110 is mechanically connected to the rotary hub 121 of the electric generator 120. In particular, the rotary hub 121 has a cylindrical shape and comprises a recess, typically a tube-shaped recess located on the external surface of the rotary hub 121, which houses the rotary magnetic assembly 122, advantageously a permanent magnets rotary magnetic assembly.

The electric generator 120 further comprises a stationary magnetic assembly 123, advantageously comprising electromagnets, which is arranged around the rotary magnetic assembly 122 (i.e. faces the rotary magnetic assembly 122). Advantageously, the stationary magnetic assembly 123 and the rotary magnetic assembly 122 define a gap between them. As it will be better explained in the following, according to one or more embodiments, the expander generator 100 may further comprise a cooling system configured to circulate a cooling fluid to cool the rotary magnetic assembly 122 and/or the stationary magnetic assembly 123 of the electric generator 120. In particular, the cooling fluid may circulate in the gap between the rotary magnetic assembly 122 and the stationary magnetic assembly 123.

With non-limiting reference to FIG. 1, the expander generator 100 further comprises at least one magnetic bearing 130 acting on the rotary hub 121, in particular supporting the rotary hub 121. According to the embodiment of FIG. 1, the at least one magnetic bearing 130 is a radial magnetic bearing. Preferably, the at least one magnetic bearing 130 is located between the impeller 110 and the rotary magnetic assembly 122 and the stationary magnetic assembly 123 of the electric generator 120. It is to be noted that the casing 140 further houses the at least one magnetic bearing 130. In particular, a rotary element of the at least one magnetic bearing 130 is integral with the rotary hub 121 and a stator element of the at least one magnetic bearing 130 is integral with the casing 140.

As shown in FIG. 1, the at least one magnetic bearing 130 is fluidly coupled to the machine inlet 111 and is configured to be cooled by a flow of hydrogen taken from the machine inlet 111. In other words, a portion of the hydrogen fed to the machine inlet 111 is not expanded by the impeller 110 but is supplied the at least one magnetic bearing 130 to cool it; in particular, the hydrogen may flow at least in a gap between the rotary element and the stator element of the at least one magnetic bearing 130. It is to be noted that the portion of hydrogen used to cool the at least one magnetic bearing 130 may be defined “small” if compared with the amount of hydrogen expanded by the impeller 110.

With non-limiting reference to FIG. 1, the expander generator 100 further comprises a fluid conduit 113 fluidly coupling the machine inlet 111 and the at least one magnetic bearing 130; in particular, the expander generator 100 has one fluid conduit 113 for each machine inlet 111. Advantageously, the fluid conduit 113 is at least partially defined by a rear surface of the impeller 110; more advantageously, the fluid conduit 113 is at least partially defined by a rear surface of the impeller 110 and an inner wall of the casing 140. In other words, the portion of hydrogen supplied to the at least one magnetic bearing 130 flows through the fluid conduit 113. Preferably, one or more sealing element is located upstream the at least one magnetic bearing 130, e.g. labyrinth seal and/or sliding ring seal. For example, the seal may be located in the fluid conduit 113 or at the rotary hub 121, in particular between the impeller 110 and the at least one magnetic bearing 130. It is to be noted that the temperature of hydrogen downstream the magnetic bearing 130 is higher than the temperature upstream the magnetic bearing 130 (therefore, it can be referred to as “heated hydrogen”) due to the heat removed from the bearing.

According to the embodiment shown in FIG. 1, the heated hydrogen downstream the magnetic bearing 130 is discharged outside the casing 140. Advantageously, the hydrogen flows through a dedicated channel defined in the casing 140 which allows the hydrogen to flow outside the casing 140.

Preferably, the impeller 110 further comprises at least one inner channel 114 which fluidly couples the fluid conduit 113 and the impeller vanes, so that the pressures (and consequently the forces) acting on the impeller, in particular on the rear surface of the impeller and a front surface of the impeller, i.e. the surface where impeller vanes are located, are balanced.

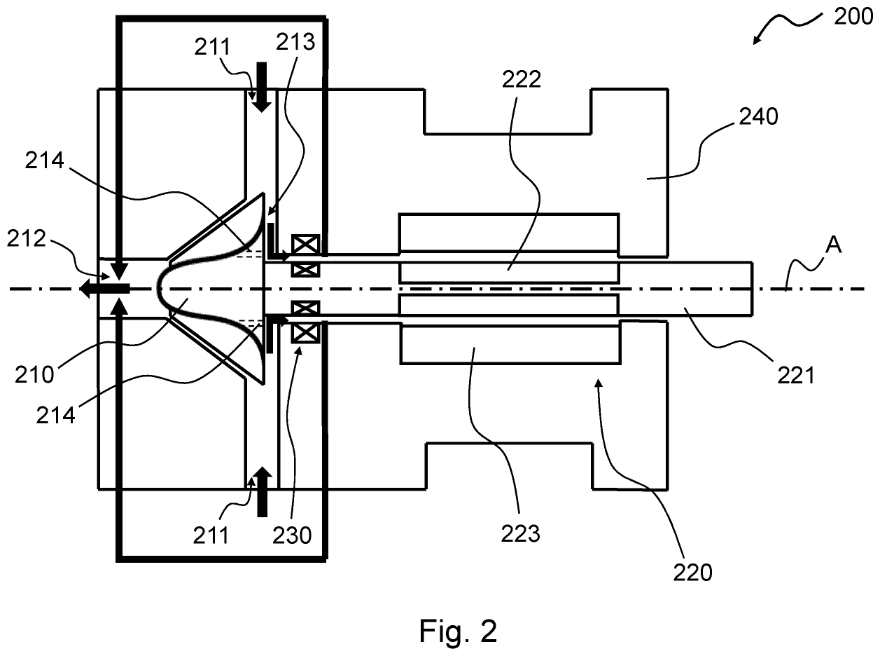

A second embodiment 200 of an expander generator will be described in the following with the aid of FIG. 2. It is to be noted that elements 210, 211, 212, 213, 214, 220, 221, 222, 223, 230 and 240 in FIG. 2 may be identical or similar respectively to elements 110 (impeller), 111 (machine inlet), 112 (machine outlet), 113 (fluid conduit), 114 (inner channel), 120 (electric generator), 121 (rotary hub), 122 (rotary magnetic assembly), 123 (stationary magnetic assembly), 130 (magnetic bearing) and 140 (casing) in FIG. 1 and perform the same or similar functions. It is also to be noted that the only difference between FIG. 1 and FIG. 2 is the circulation of hydrogen in the machine, as it will be apparent from the following.

According to the embodiment of FIG. 2, the at least one magnetic bearing 230 (which in particular is a radial magnetic bearing) is fluidly coupled also to the machine outlet 212, so that the cooling fluid, i.e. the hydrogen from machine inlet 211, flows through the fluid conduit 213, removes heat from the at least one magnetic bearing 230 and then is discharged to the machine outlet 212. In other words, the at least one magnetic bearing 230 is configured to discharge a flow of heated hydrogen at the outlet 212; in particular, the heated hydrogen discharged by the at least one magnetic bearing 230 is mixed with the expanded hydrogen expanded by the impeller 210 at the machine outlet 212 (see the black arrows starting from downstream the radial magnetic bearing 230 and ending at the machine outlet 212).

It is to be noted that both the rotary hub 121 of FIG. 1 and the rotary hub 221 of FIG. 2 are longer than the casing 140 and 240; in other words, the rotary hub 121 and 221 may end up outside the casing 140 and 240. As well known, a rotary shaft or hub is advantageously supported by two radial magnetic bearings, typically located at the ends of the rotary shaft or hub; according to a possibility, the rotating hub 121 and 221 may be supported by a second bearing (which may be a rolling bearing or a magnetic bearing) located outside the casing 140 and 240.

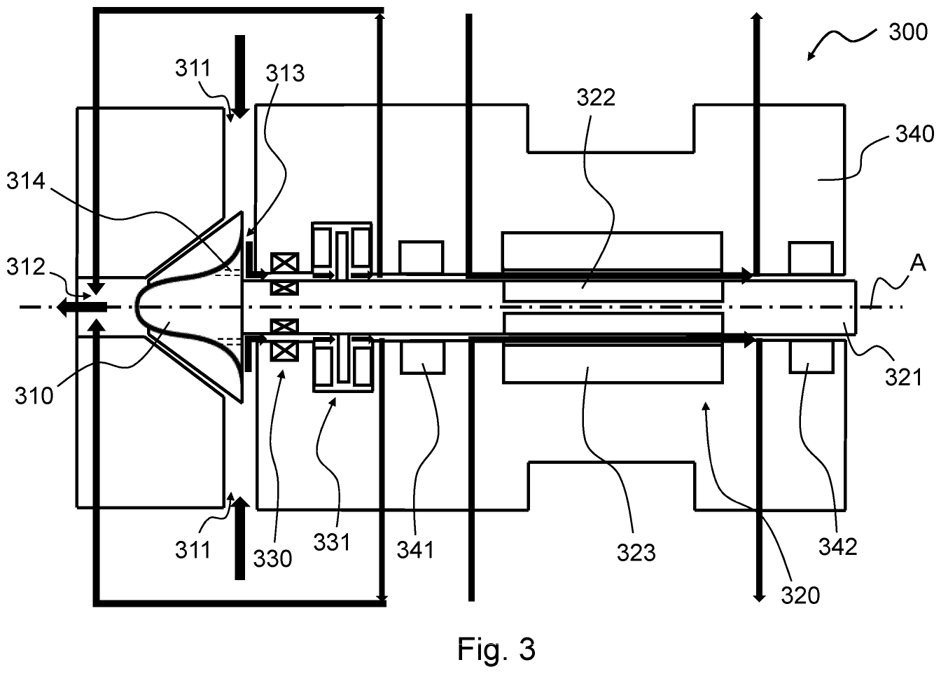

A third embodiment 300 of an expander generator will be described in the following with the aid of FIG. 3. It is to be noted that elements 310, 311, 312, 313, 314, 320, 321, 322, 323, 330 and 340 in FIG. 3 may be identical or similar respectively to elements 110 (impeller), 111 (machine inlet), 112 (machine outlet), 113 (fluid conduit), 114 (inner channel), 120 (electric generator), 121 (rotary hub), 122 (rotary magnetic assembly), 123 (stationary magnetic assembly), 130 (magnetic bearing) and 140 (casing) in FIG. 1 and perform the same or similar functions.

According to the embodiment of FIG. 3, the expander generator 300 has two magnetic bearings, in particular a radial magnetic bearing 330 and a thrust magnetic bearing 331 located downstream the radial magnetic bearing 330. It is to be noted that, according to a possibility not shown in any figure, the positions of the bearings could also be switched (i.e. the thrust magnetic bearing 331 may be located upstream the radial magnetic bearing 330). Both the magnetic bearings 330 and 331 may be cooled by a flow of compressed hydrogen from the machine inlet 311, in particular may be cooled in series. As already mentioned, a portion of the hydrogen fed to the machine inlet 311 is supplied for example firstly to the radial magnetic bearing 330 and then to the thrust magnetic bearing 331 to cool them, in particular flowing at least in a gap between the rotary element and the stator element of the magnetic bearings 330 and 331 (see the small black arrows in FIG. 3). As described above, the portion of hydrogen may flow from the machine inlet 311 through the fluid conduit 313 partially defined by the rear surface of the impeller 310 to reach the magnetic bearings 330 and 331. It is to be noted that the hydrogen may be pumped by a disk of the thrust magnetic bearing 331 (that may have one or more suitably-shaped pumping surfaces and/or one or more suitably-shaped pumping devices) and discharged e.g. radially from the thrust magnetic bearing 331.

It is to be noted that the temperature of hydrogen downstream the magnetic bearings 330 and 331 is higher than the temperature upstream the magnetic bearings 330 and 331 (therefore, it can be referred to as “heated hydrogen”) due to the heat removed from the bearings. Advantageously, the heated hydrogen downstream the magnetic bearings 330 and 331 is discharged to the outlet 312 and mixed with the hydrogen expanded by the impeller 310.

According to the embodiment shown in FIG. 3, the rotary magnetic assembly 322 and possibly the stationary magnetic assembly 323 are cooled by cooling fluid(s), in particular by cooling fluid(s) supplied by external source(s). It is to be noted that this could be particularly useful to minimize pressure losses of the machine; in fact, the magnetic bearings 330 and 331 may be cooled by a portion of the hydrogen fed to the machine inlet 311, while the electric generator 320 may be cooled by one or more cooling fluid which may have a lower pressure with respect to the hydrogen used to cool the magnetic bearings 330 and 331, reducing therefore the pressure losses due to cooling. For example, the cooling fluid is supplied into the casing 340 and is arranged to circulate in the gap which is defined between the rotary magnetic assembly 322 and the stationary magnetic assembly 323. However, the stationary magnetic assembly 323 and/or the rotary magnetic assembly 322 may be cooled by the cooling fluid according to other suitable circulation configurations. For example, the rotary magnetic assembly 322 and possibly also at least partially the stationary magnetic assembly 323 may be cooled by a first cooling fluid circulating in the gap which is defined between the rotary magnetic assembly 322 and the stationary magnetic assembly 323 and the stationary magnetic assembly 323 may be cooled also by a second cooling fluid, which for example may circulate inside the stationary magnetic assembly 323.

Advantageously, the expander generator machine 300 comprises further at least one dry gas seal 341. According to the example shown in FIG. 3, the expander generator machine 300 has two dry gas seals 341 and 342: a first dry gas seal 341 may be located at a first end of the stationary and rotary magnetic assembly 323 and 322, in particular between the first end and the magnetic bearings 330 and 331, and a second dry gas seal may be located at a second end of the stationary and rotary magnetic assembly 323 and 322. According to a variant of the example shown in FIG. 3, dry gas seal 342 is omitted. According to other possibilities, the dry gas seal 341 may be located elsewhere. Advantageously, dry gas seal 341 helps to isolate the impeller 310 and the electric generator 320, in particular helps to isolate the fluid expanded by the impeller (which is used also to cool the magnetic bearing(s)) and the cooling fluid (which is used to cool the stationary magnetic assembly and/or the rotary magnetic assembly). Advantageously, dry gas seal 342 helps to isolate the electric generator 320 from the ambient surrounding the machine, in particular surrounding the casing 340.

According to a possibility, the cooling fluid is different from the fluid expanded by the impeller (i.e. hydrogen), for example is air or water. According to another possibility, cooling fluid is hydrogen, for example hydrogen fed to the machine inlet or hydrogen at lower pressure with respect to the machine inlet, in particular hydrogen coming from the machine outlet.

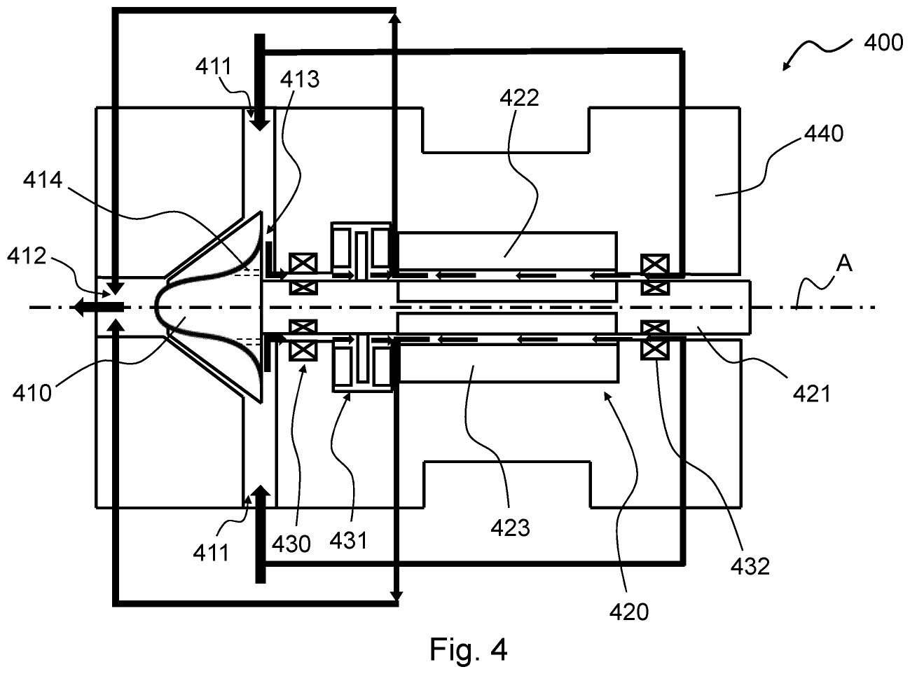

A fourth embodiment 400 of an expander generator will be described in the following with the aid of FIG. 4. It is to be noted that elements 410, 411, 412, 413, 414, 420, 421, 422, 423, 430 and 440 in FIG. 4 may be identical or similar respectively to elements 110 (impeller), 111 (machine inlet), 112 (machine outlet), 113 (fluid conduit), 114 (inner channel), 120 (electric generator), 121 (rotary hub), 122 (rotary magnetic assembly), 123 (stationary magnetic assembly), 130 (magnetic bearing) and 140 (casing) in FIG. 1 and perform the same or similar functions.

According to the embodiment of FIG. 4, the expander generator 400 has three magnetic bearings, in particular first radial magnetic bearing 430, a thrust magnetic bearing 431 located downstream the radial magnetic bearing 430 (it is to be noted that the positions could also be switched) and a second radial magnetic bearing 342. Some (advantageously all) of the magnetic bearings 430, 431 and 432 may be cooled by a flow of hydrogen from the machine inlet 411, in particular may be cooled in series and/or in parallel as it will better explained in the following.

With non-limiting reference to FIG. 4, a first portion of the hydrogen fed to the machine inlet 411 is supplied for example firstly to the radial magnetic bearing 430 and then to the thrust magnetic bearing 431 to cool them, in particular flowing at least in a gap between the rotary element and the stator element of the magnetic bearings 430 and 431 (see the small black arrows in FIG. 4), and finally the heated hydrogen is discharged to the machine outlet 412 (see the black arrows starting from downstream the thrust magnetic bearing 431 and ending at the machine outlet 412). In other words, the magnetic bearings 430 and 431 are cooled in series.

With non-limiting reference to FIG. 4, a second portion of the hydrogen fed to the machine inlet 411 is supplied for example firstly to the radial magnetic bearing 432 and then to the electrical generator 420, in particular circulating in the gap between the rotary magnetic assembly 422 and the stationary magnetic assembly 423. In other words, the magnetic bearing 432 and the electrical generator 420 are cooled in series. According to another possibility not shown in figures, the second portion of the hydrogen fed to the machine inlet 411 is supplied only to the electrical generator 420 to cool it.

Advantageously, the heated hydrogen downstream the thrust magnetic bearing 431 and the heated hydrogen downstream the electric generator 420 (i.e. after circulating in the gap between the rotary magnetic assembly 422 and the stationary magnetic assembly 423) are discharged to the machine outlet 412.

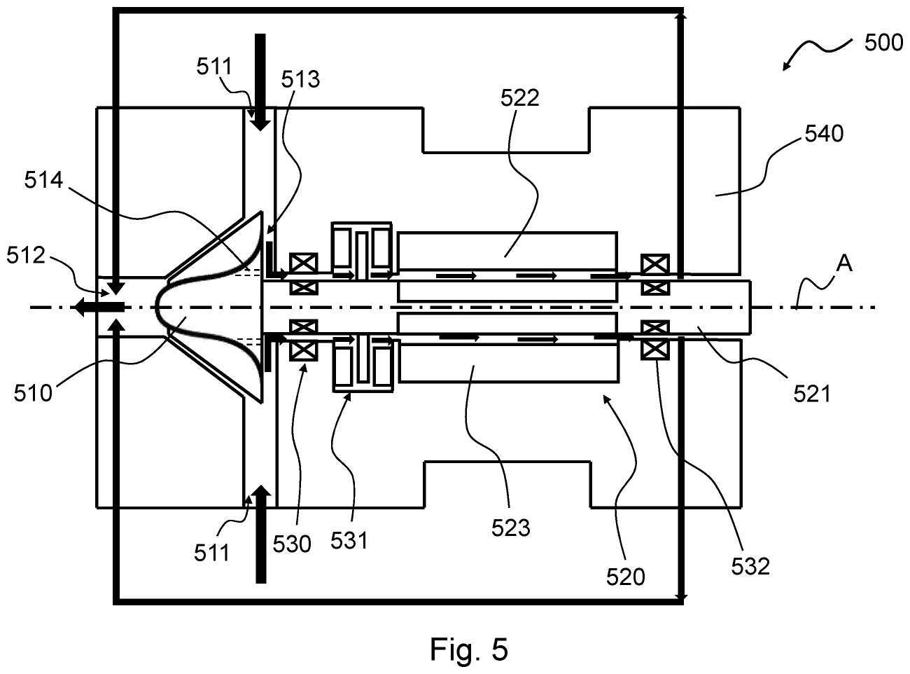

It is to be noted that, according to the example shown in FIG. 4, the magnetic bearings 430 and 431 and the magnetic bearing 432 and the electrical generator 420 are cooled in parallel; however, different configurations may be applied (see for example FIG. 5). For example, the magnetic bearing(s) and the electric generator may be cooled in series, supplying hydrogen firstly to the at least one magnetic bearing and then to the electric generator or firstly to the electric generator and then to the at least one magnetic bearing.

In FIG. 5 is shown another embodiment which is similar to the embodiment of FIG. 4 but differs in that the above-mentioned first portion and the second portion of hydrogen used to cool the magnetic bearings 530, 531 and 532 and the electric generator 520 are a same flow of hydrogen. In particular, with non-limiting reference to FIG. 5, a portion of the hydrogen fed to the machine inlet 511 flows through the fluid conduit 513 and is used to cool in series: the first radial magnetic bearing 530, the thrust magnetic bearing 531, the electric generator 520 and the second radial magnetic bearing 532. Finally, the portion of hydrogen downstream the second radial magnetic bearing 532 is discharged as heated hydrogen at the machine outlet 512 and preferably is mixed with the expanded hydrogen expanded by the impeller 510.

According to another possibility, not shown in any figures, the thrust magnetic bearing 531 may be located downstream of the electric generator 520 and being cooled in by the portion of the hydrogen fed to the machine inlet 511 which flows through the fluid conduit 513 and which is used to cool in series: the first radial magnetic bearing 530, the electric generator 520, the thrust magnetic bearing 531 and finally the second radial magnetic bearing 532. According to still another possibility, not shown in any figures, the thrust magnetic bearing 531 may be located downstream of the second radial magnetic bearing 532 and being cooled in by the portion of the hydrogen fed to the machine inlet 511 which flows through the fluid conduit 513 and which is used to cool in series: the first radial magnetic bearing 530, the electric generator 520, the second radial magnetic bearing 532 and finally the thrust magnetic bearing 531.

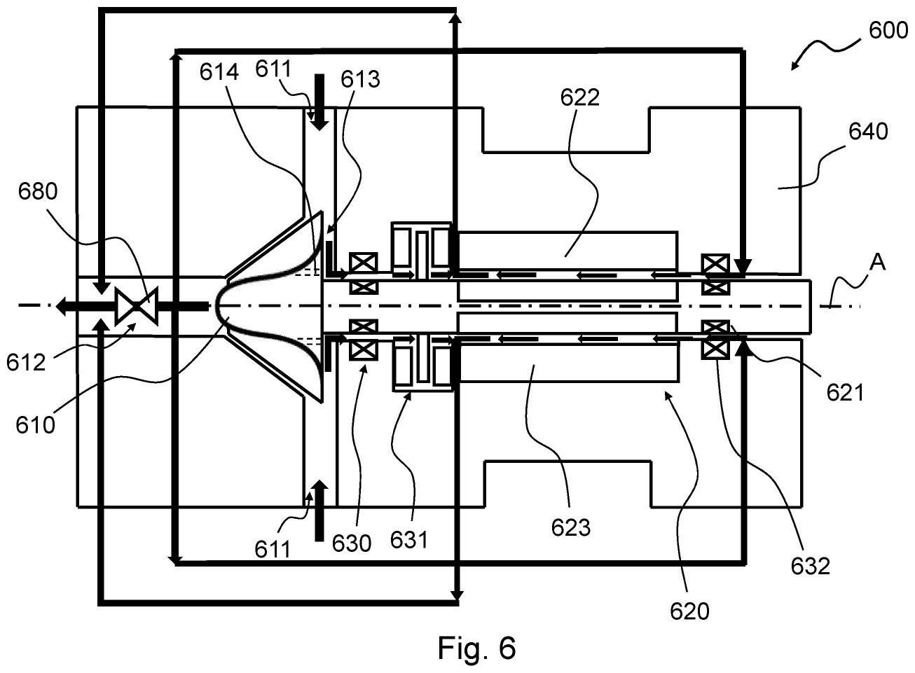

A sixth embodiment 600 of an expander generator will be described in the following with the aid of FIG. 6. It is to be noted that elements 610, 611, 612, 613, 614, 620, 621, 622, 623, 630 and 640 in FIG. 6 may be identical or similar respectively to elements 110 (impeller), 111 (machine inlet), 112 (machine outlet), 113 (fluid conduit), 114 (inner channel), 120 (electric generator), 121 (rotary hub), 122 (rotary magnetic assembly), 123 (stationary magnetic assembly), 130 (magnetic bearing) and 140 (casing) in FIG. 1 and perform the same or similar functions. It is to be noted that the embodiment of FIG. 6 is similar to the embodiment of FIG. 4; the only difference between FIG. 6 and FIG. 4 is that the second portion of hydrogen used to cool the radial magnetic bearing 632 and the electrical generator 620 is supplied by the machine outlet 612, as it will be apparent from the following.

With non-limiting reference to FIG. 6, a portion of the hydrogen fed to the machine inlet 611 is supplied for example firstly to the radial magnetic bearing 630 and then to the thrust magnetic bearing 631 to cool them, in particular flowing at least in a gap between the rotary element and the stator element of the magnetic bearings 630 and 631 (see the small black arrows in FIG. 6), and finally the heated hydrogen is discharged to the machine outlet 612 (see the black arrows starting from downstream the thrust magnetic bearing 631 and ending at the machine outlet 612). In other words, the magnetic bearings 630 and 631 are cooled in series.

With non-limiting reference to FIG. 6, the radial magnetic bearing 632 and the electrical generator 620 may be cooled by a portion of the hydrogen supplied by the machine outlet 612, in particular a portion of the hydrogen discharged by the impeller 610. Advantageously, the machine 600 is provided with a control valve 680 located at the machine outlet 612 in order to allow the extraction of hydrogen from the machine outlet 612. In fact, the control valve 680 causes a pressure drop, in particular a small pressure drop in a range of 1-1.5 bar, to allow the circulation of hydrogen as it will be better described in the following.

According to the embodiment of FIG. 6, a portion of the hydrogen from the machine outlet 612 is supplied for example firstly to the radial magnetic bearing 632 and then to the electrical generator 620, in particular circulating in the gap between the rotary magnetic assembly 622 and the stationary magnetic assembly 623. In other words, the magnetic bearing 632 and the electrical generator 620 are cooled in series.

Advantageously, the heated hydrogen downstream the thrust magnetic bearing 631 and the heated hydrogen downstream the electric generator 620 (i.e. after circulating in the gap between the rotary magnetic assembly 622 and the stationary magnetic assembly 623) may be merged and discharged to the machine outlet 612, in particular downstream the control valve 680.

According to another possibility, not shown in any figures, the magnetic bearing 632 and the electrical generator 620 may be cooled in parallel. In other words, the portion of the hydrogen from the machine outlet 612 may be supplied between the electric generator 620 and the rotary magnetic assembly 622, so that a first part of hydrogen may flow through the gap between the rotary magnetic assembly 622 and the stationary magnetic assembly 623 in order to cool the electric generator 620 and a second part of hydrogen may flow through the gap between the rotary element and the stator element of the radial magnetic bearing 632 in order to cool the radial magnetic bearing 632. Advantageously, the first part of hydrogen, after the cooling of the electric generator 620 (i.e. downstream the electric generator 620), may be merged to the heated hydrogen downstream the thrust magnetic bearing 631 and discharged to the machine outlet 612, in particular downstream the control valve 680. Advantageously, the second part of hydrogen, after the cooling of the radial magnetic bearing 632 (i.e. downstream the radial magnetic bearing 632), may be merged to the heated hydrogen downstream the thrust magnetic bearing 631 and discharged to the machine outlet 612, in particular downstream the control valve 680.

It is to be noted that, for the sake of clarity, in FIGS. 2, 3, 4, 5 and 6 the hydrogen flows used to cool the radial magnetic bearing and/or the thrust magnetic bearing and/or the electrical generator are shown outside the casing of the machine. However, the casing of the machine may be provided with suitable channels in order to circulate hydrogen flows inside the casing.

According to some embodiments (not shown in figures), the expander generator machine, for example machines 100, 200, 300, 400,500 and 600 in the figures, may comprise a second impeller. It is to be noted that the second impeller may be an expander or a compressor to respectively expand or compress the hydrogen supplied to the machine. In particular, the second impeller may be located at the same end of the expander generator machine as the first impeller 110, 210, 310, 410, 510 and 610 (i.e. at the same rotary hub end) or may be located at the opposite end with respect to the first impeller 110, 210, 310, 410, 510 and 610 (i.e. at the opposite rotary hub end). The supply of hydrogen from the machine inlet 112, 212, 312, 412, 512 and 612 to the first impeller and the second impeller may be in series or in parallel. According to an advantageous possibility, if the expander generator machine has the second impeller located at the opposite rotary hub end with respect to the first impeller and the supply of hydrogen to the first and second impeller is in parallel, the thrust magnetic bearing may be omitted.

In conclusion, expander generator machines 100, 200, 300, 400, 500 and 600 may utilize portion(s) of the fluid to be expanded by the impeller to cool at least one magnetic bearing of the machine and advantageously also the electric generator. Preferably, the expander generator machines 100, 200, 300, 400, 500 and 600 are arranged so that, during operation of the machine, pressure of an environment inside the casing is higher than pressure of an environment outside the casing; in other words, the casing is pressurized so that the surrounding environment can not leakage in the casing. Even more preferably, during the installation or before the start-up of machines 100, 200, 300, 400, 500 and 600, the environment inside the casing is evacuated of oxygen in order to avoid the risk of fire and/or explosion.

1. An expander generator machine having a machine inlet and a machine outlet and comprising:
an impeller configured to receive compressed hydrogen from the machine inlet, expand the compressed hydrogen through impeller vanes and discharge expanded hydrogen at the machine outlet,
an electric generator configured to generate electrical energy and comprising a rotary hub, a rotary magnetic assembly mechanically coupled to the rotary hub and a stationary magnetic assembly arranged around the rotary magnetic assembly,
at least one magnetic bearing acting on the rotary hub,
a casing housing the impeller, the electric generator and the at least one magnetic bearing,
wherein the impeller is mechanically connected to the rotary hub, wherein the at least one magnetic bearing is fluidly coupled to the inlet, and is configured to be cooled by a flow of hydrogen from the machine inlet.

2. The expander generator machine of claim 1, wherein at least one magnetic bearing is located between the impeller and the electric generator.

3. The expander generator machine of claim 1, being arranged so that, during operation of the machine, pressure of an environment inside the casing is higher than pressure of an environment outside the casing.

4. The expander generator machine of claim 1, being arranged so that an environment inside the casing is oxygen free.

5. The expander generator machine of claim 1, wherein the at least one magnetic bearing is fluidly coupled to the machine outlet, and is configured to discharge a flow of heated hydrogen at the outlet.

6. The expander generator machine of claim 1, further comprising a fluid conduit which fluidly couples the machine inlet and the at least one magnetic bearing, wherein the fluid conduit is at least partially defined by a rear surface of the impeller.

7. The expander generator machine of claim 6, wherein the impeller comprises at least one inner channel fluidly coupling the fluid conduit and the impeller vanes.

8. The expander generator machine of claim 1, further comprising a cooling system configured to circulate a cooling fluid to cool the rotary magnetic assembly and/or the stationary magnetic assembly.

9. The expander generator machine, of claim 8, wherein a gap is defined between the rotary magnetic assembly and the stationary magnetic assembly, and
wherein the cooling fluid is arranged to circulate in the gap.

10. The expander generator machine of claim 8, comprising a first cooling system configured to circulate a first cooling fluid to cool the rotary magnetic assembly and possibly also the stationary magnetic assembly and a second cooling system configured to circulate a second cooling fluid to cool the stationary magnetic assembly.

11. The expander generator machine of claim 8, wherein the cooling fluid is hydrogen.

12. The expander generator machine of claim 10, wherein both the first cooling fluid and the second cooling fluid are hydrogen.

13. The expander generator machine of claim 8, wherein the cooling system is fluidly coupled to the inlet and is configured to circulate a flow of hydrogen from the machine inlet.

14. The expander generator machine of claim 8, wherein the cooling system is fluidly coupled to the machine outlet and is configured to discharge a flow of heated hydrogen at the machine outlet.

15. The expander generator machine of claim 14, wherein the cooling system is fluidly coupled to the at least one magnetic bearing.

16. The expander generator machine of claim 14, being configured to discharge a flow of heated hydrogen from the gap and a flow of heated hydrogen from the at least one magnetic bearing to the machine outlet.

17. The expander generator machine of claim 1, wherein the at least one magnetic bearing is a first radial magnetic bearing, a thrust magnetic bearing and a second radial magnetic bearing.
